(19) United States
(12) Patent Application Publication
(10) Pub. No.: US 2014/0333135 A1
(43) Pub. Date: Nov. 13, 2014

(54) High Performance Voltage Compensation

(71) Applicant: Control Techniques Limited, Newtown (GB)

(72) Inventors: Colin Hargis, Oswestry (GB); Mark Towers, Newtown (GB); Oleksandr Melnyk, Newtown (GB)

(73) Assignee: Control Techniques Limited, Newtown (GB)

(21) Appl. No.: 14/268,735

(22) Filed: May 2, 2014

(30) Foreign Application Priority Data
May 7, 2013 (GB) 1308190.6

(51) Int. Cl. H02J 1/00

(52) U.S. Cl. CPC H02J 1/00
USPC 307/43

(57) ABSTRACT

An apparatus for producing a compensated voltage output comprising: a first power source or power sink coupled between a first node and a reference node; a second power source or power sink coupled between a second node and the reference node; a biasing means comprising one portion coupled between the first node and the reference node, and another portion coupled between the first node and the second node. The biasing means is operable to generate a controllable bias voltage of either polarity between the first and second nodes to produce the compensated voltage output.

### CROSS-REFERENCE TO RELATED APPLICATION

This application claims the benefit and priority of Great Britain Patent Application No. 1308190.6 filed May 7, 2013. The entire disclosure of the above application is incorporated herein by reference.

### FIELD

This invention relates to voltage compensation. Embodiments relate to providing voltage compensation within arrays of elements supplying a common DC inverter. It may be applied to, but is not limited to, use with photovoltaic generator systems.

### BACKGROUND

With the present drive to provide ‘green’ energy, the use of photovoltaic (PV) panels is becoming more common. However, the use of these panels is still developing. Consequently, the unit cost per panel is relatively high. When coupled with the drive to provide energy efficiently, it is clearly desirable to arrange the PV panels to be operated as efficiently as possible.

PV panels are typically connected in series strings and produce a suitable DC voltage typically for conversion to AC in an accompanying inverter or other electrical converter running in an associated power processing system.

For a given level of irradiance (exposure to the sun) and temperature, each PV panel has an optimal DC operating voltage which is typically found and followed using an automatic Maximum Power Point (MPP) tracking algorithm running in the associated power processing system. The MPP algorithm searches for the peak of the arrays P-V (power-voltage) characteristic.

The power lost in the power processing system is a large factor in the cost effective operation of PV panels. A specific difficulty with such systems is that because of the natural variation of irradiance the average power produced by the array is much less than the maximum rating of the array. The fixed power losses in the associated power processing system, being a function of the maximum rating, are therefore relatively high and they have a disproportionate effect on the overall efficiency of energy conversion.

With a large array of PV panels, a number of strings—comprising series connected panels—are often connected in a parallel arrangement. Typically, a large common inverter is connected across the parallel connected strings. The large common inverter can be cost-effectively designed with multiple power devices (semiconductors) which can be controlled so that only those required for the prevailing level of power generation are active. The losses, and especially the fixed losses, of the individual devices are therefore adapted to the level of power generation.

The disadvantage of this arrangement is that the MPP tracking algorithm in the inverter can only adjust the voltage across all of the series strings in common. Differences in the voltages produced by each PV string in the array, such as those caused by differing temperature, sun angle, shading, and a non-uniform ageing process in each panel etc., cannot be catered for.

Alternatively, each series string of PV panels may be connected with its own smaller inverter. The advantage of employing an inverter associated with each series string is that each string may be provided with an independent MPP tracking algorithm and control system. The cost of individual inverters is high. This arrangement exhibits reduced efficiency at other than maximum rated power because the inverter cannot be cost-effectively adapted to the power demand. The fixed losses of each inverter consume a higher proportion of power produced by each string.

There is, therefore, a need to improve the adaptability of voltage generating arrays of elements in an efficient and cost-effective way. A conventional approach to this problem would be to use some form of DC/DC converters between the strings and the input of the common inverter. This has the disadvantage that the entire power throughput of the inverter would pass through this additional stage of power conversion, incurring additional losses proportionate to that power throughput.

### SUMMARY

The invention is set out in the claims. Optional features are defined in the dependent claims.

According to a first aspect there is provided an apparatus for producing a compensated voltage output as defined in Claim 1 of the appended claims.

Thus there is provided an apparatus comprising a first power source or power sink coupled between a first node and a reference node, a second power source or power sink coupled between a second node and the reference node, a biasing means comprising one portion coupled between the first node and the reference node, and another portion coupled between the first node and the second node, wherein the biasing means is operable to generate a controllable bias voltage of either polarity between the first and second nodes to produce the compensated voltage output.

Optionally, the two portions of the biasing means are coupled by a transformer.

Optionally, both portions of the biasing means are active.

Optionally, the biasing means is arranged such that the power throughput of the biasing means is proportionate only to the bias voltage generated by the biasing means.

Optionally, one of the first and second power source or sink comprises a photovoltaic module or photovoltaic cell.

Optionally, the apparatus further comprises a plurality of photovoltaic modules or cells coupled together in series and wherein the biasing means and the photovoltaic modules form a compensatable series string with voltage output terminals.

Optionally, the apparatus comprises a plurality of the series strings being coupled in parallel such that the output terminals of the series strings provide a common photovoltaic module array output.

Optionally, one portion of the biasing means is rated for at least the maximum voltage of one of the power sources or power sinks, and the other portion is rated for at least the maximum current rating of one of the power sources or power sinks.

Optionally, the apparatus is further arranged to enable the direction of current flow in the portion of the biasing means coupled between the first and second nodes to be reversed.

Optionally, the apparatus is arranged such that energy may be transferred from either side of the transformer of the biasing means to the other side of the transformer.

Optionally, the apparatus further arranged such that the biasing means may be bypassed to directly connect the first and the second nodes.

Optionally, at least one portion of the biasing means comprises MOSFET and/or IGBT switches.

Optionally, the switches are arranged so as to negate the effects of parasitic diodes of the switches.

Optionally, the parasitic diodes of a switch are negated by placing a second switch in series so that the connection between the switches joins the anodes of both parasitic diodes or the cathodes of both parasitic diodes.

Optionally, the apparatus is further arranged such that the portion of the biasing means coupled between the first node and the reference node may be selectively swapped to be alternatively coupled between the second node and the reference node.

Optionally, at least one portion of the biasing means comprises a push-pull arrangement.

Optionally, at least one portion of the biasing means comprises a half bridge arrangement.

Optionally, at least one portion of the biasing means comprises a full bridge arrangement.

Optionally, at least one portion of the biasing means comprises an NPC half bridge arrangement.

Optionally, at least one portion of the biasing means comprises an NPC full bridge arrangement.

Optionally, the biasing means further comprises a control device, first node and second node voltage measuring means, and is arranged such that the control device is operable to control the bias voltage imposed between the first and second nodes to produce the compensated voltage output.

Optionally, the apparatus wherein the control device is arranged to control the current flowing in the biasing means.

Optionally, the control device comprises an input for receiving a control signal such that the bias voltage is controllable by the received control signal.

Optionally, the control device further comprises data communication means for providing power sink or source operating data to a monitoring device such that operating parameters of the power sink or source can be remotely monitored.

Optionally, the control device is further arranged to select the polarity of the bias voltage between the first and second nodes.

Optionally, the control device is further arranged to bypass the biasing means by connecting the first and second nodes directly.

Optionally, the other of the first and second power source or sink comprises a PV inverter.

Optionally, one or both of the first and second power source or sink comprises a DC link of an inverter.

Optionally, the AC output of the inverter is connected to the electricity grid.

Optionally, the polarity of the bias voltage is selectable.

According to a second aspect there is provided method of providing a compensated voltage output as defined in claim 17. Thus there is provided a method comprising the steps of modulating a first voltage with a bias voltage generated by the biasing means such that the first voltage is selectively modulated by a controllable bias voltage of either polarity to produce the compensated voltage.

Optionally, the method further comprises the steps of measuring the power generated or dissipated in either the first or second power source or power sink, inputting the measurements to a maximum power point algorithm of a control device of the biasing means, providing a control output from the control device to control the biasing voltage imposed by the biasing means between the first and second nodes.

Optionally, the method further comprises the steps of receiving at the control device, an input signal from an external device external to the circuit where the biasing means is positioned and adjusting the control output such that the biasing voltage is controllable by the external device.

Optionally, the method further comprises the step of providing power sink or source operating data to a monitoring device such that operating parameters of at least one power sink or source can be remotely monitored.

Optionally the method further comprises the step of exposing at least one photovoltaic module or photovoltaic cell to light such that the first voltage is produced by the photovoltaic module or cell.

Optionally, the method further comprises the step of selecting a boost or buck mode of operation of the biasing means to produce the compensated voltage.

With all the aspects, preferable and optional features are defined in the dependent claims.

The term ‘bidirectional in relation to converter action is referred to in the various embodiments described herein and should be taken to mean a converter that is able to transfer power in either direction. In a bias converter connected to a system where the direction of current is fixed (such as a PV system) this will allow a bias voltage of either polarity to be produced from the same apparatus arrangement.

### BRIEF DESCRIPTION OF THE DRAWINGS

Embodiments will now be described, by way of example only, and with reference to the drawings in which:

FIG. 1A illustrates systematically a converter arrangement in accordance with the embodiments described herein;

FIG. 1B illustrates a voltage compensation system for photovoltaic panels in accordance with the embodiments described herein;

FIG. 2 illustrates systematically a converter arranged in relation to two power sources;

FIG. 3 illustrates an embodiment comprising bi-directional voltage compensation comprising a push pull-push pull arrangement;

FIG. 4 illustrates an embodiment comprising bi-directional voltage compensation comprising a half bridge-push pull arrangement;

FIG. 5 illustrates an embodiment comprising bi-directional voltage compensation comprising a half bridge-half bridge arrangement;

FIG. 6 illustrates an embodiment comprising bi-directional voltage compensation comprising a full bridge-push pull arrangement;

FIG. 7 illustrates an embodiment comprising bi-directional voltage compensation comprising a full bridge-half bridge arrangement;

FIG. 8 illustrates an embodiment comprising bi-directional voltage compensation comprising a full bridge-full bridge arrangement;

FIG. 9 illustrates an embodiment comprising bi-directional voltage compensation comprising an NPC (neutral point clamped) half bridge-push pull arrangement;

FIG. 10 illustrates an embodiment comprising bi-directional voltage compensation comprising an NPC half bridge-half bridge arrangement;

FIG. 11 illustrates an embodiment comprising bi-directional voltage compensation comprising an NPC half bridge-full bridge arrangement;

FIG. 12 illustrates an embodiment comprising bi-directional voltage compensation comprising an NPC half bridge-NPC half bridge arrangement;

FIG. 13 illustrates an embodiment comprising bi-directional voltage compensation comprising an NPC full bridge-push pull arrangement;

FIG. 14 illustrates an embodiment comprising bi-directional voltage compensation comprising an NPC full bridge-half bridge arrangement;

FIG. 15 illustrates an embodiment comprising bi-directional voltage compensation comprising an NPC full bridge-full bridge arrangement;

FIG. 16 illustrates an embodiment comprising bi-directional voltage compensation comprising an NPC full bridge-NPC half bridge arrangement;

FIG. 17 illustrates an embodiment comprising bi-directional voltage compensation comprising an NPC full bridge-NPC full bridge arrangement;

FIG. 18 illustrates an embodiment where the parasitic diodes of semiconductor switches are arranged so as to be opposed to one another;

FIG. 19 illustrates an embodiment comprising an additional ‘transparent’ mode;

FIG. 20 illustrates an embodiment comprising a secondary circuit to allow current to pass through the current rated side when no bias is being produced;

FIG. 21 illustrates an embodiment as shown in FIG. 3 with a maximum power point tracking controller and associated support components;

FIG. 22 illustrates a flow diagram of controller operation when tracking MPP; and

FIG. 23 illustrates an embodiment where recirculating energy may be avoided.

In the figures, like elements are indicated by like reference numerals throughout.

### OVERVIEW

By way of an overview, in a voltage compensation system, series strings of PV modules, or parallel groups of series strings, are each provided with an associated DC/DC converter coupled in series with the string. When the PV modules are exposed to sunlight and hence producing a DC voltage, the converter imposes a bias voltage on the DC voltage of the series string. This results in a string voltage across the string that is not solely dependent on the working voltage of the series string of PV modules for a given level of sunlight.

An MPP tracking algorithm controls the DC/DC converter such that the maximum power output point (or as close to it as is possible) of each string and converter may be maintained.

When multiple series strings are connected in parallel such that they provide a common array output, a common inverter may be coupled to the array. The inverter is controlled in such a way as to determine the DC voltage, and hence the voltage of the entire PV array. This, in turn, affects the voltage at which the PV series strings operate.

In traditional arrangements of DC/DC converter used with one or more PV cells possibly arranged as series strings connected in parallel, the entire power from the PV cell (or string) passes through the DC/DC converter. The power rating for the converter must be the same as that for the cell or string. This results in reduced efficiency of the DC/DC converter.

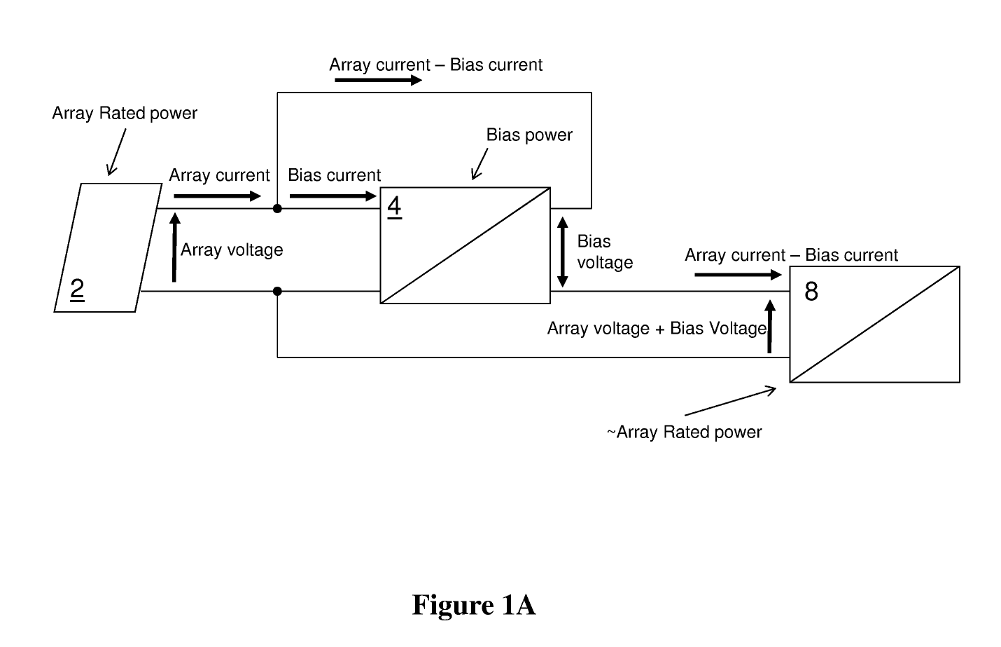

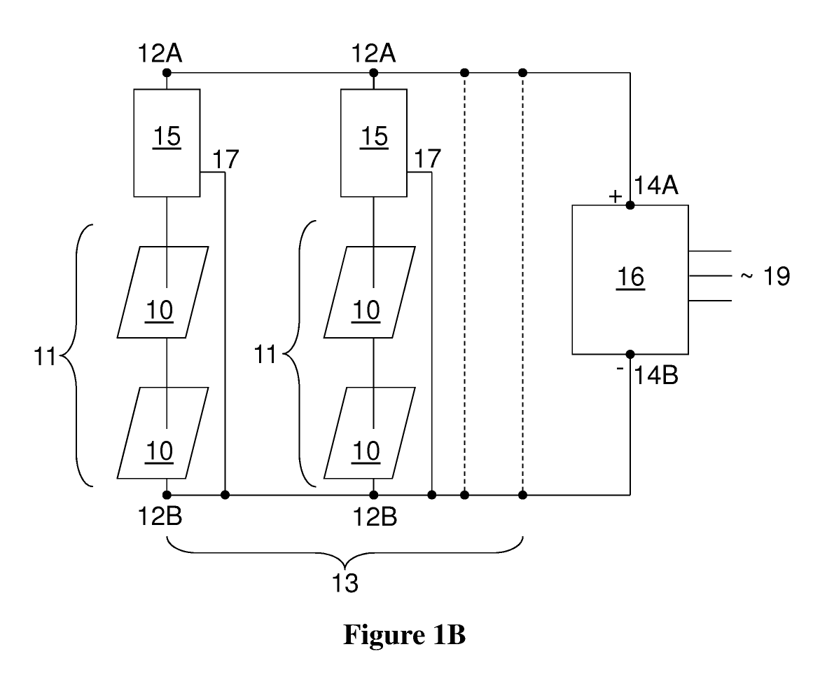

FIG. 1A illustrates an arrangement whereby the PV cells or string 2 are arranged in combination with the DC/DC converter 4 so that the output 8 of the circuit comes from a combination of the cells or string 2 and the DC/DC converter 4, rather than being solely from the converter 4. Because of this arrangement, the converter 4 in FIG. 1A can be operated to contribute a bias voltage to the voltage across the cells or string 2, so that the overall output 8 of the circuit matches a target voltage. The bias voltage may add to or subtract from the voltage contributed by the cells or string 2, dependent on the target voltage which is to be met. This is represented by the bidirectional arrow in FIG. 1A denoting the alternative “boost” and “buck” configurations available with the arrangements described herein.

Because the converter 4 in FIG. 1A only contributes a bias voltage used to make a relatively small change to the voltage or current of the PV cells or string 2, the power transferred within the converter 4 is only a function of the amount of the bias itself, not of the entire output 8 of the string 2 and converter 4 in combination. As the skilled reader will appreciate, the losses of a DC/DC converter are inevitably a function of its power throughout its operation.

Therefore, in the arrangement shown in FIG. 1A, the losses of the DC/DC converter 4 are proportionate only to the amount of the bias which it contributes. The converter power rating need only therefore equal or exceed maximum bias power. It need not equal the maximum power for the cells or string 2.

Additionally, an individual DC/DC converter can be provided for each string in series therewith. With an associated converter in series with each series string, the optimum voltage output conditions of each PV module, and hence the maximum power output point of each string as a whole may be maintained regardless of any inverter parameter changes. Furthermore, each string may output a different optimum DC voltage to the other strings in an array as the respective converter buffers each string from the other strings in the array.

### DETAILED DESCRIPTION

FIG. 1B shows such an arrangement. As shown therein, multiple PV modules 10 are coupled together in series strings 11 or groups of series strings 11. A series string may also comprise a single PV module or a single PV cell. Each series string 11 has output terminals 12A, 12B. The series strings 11 may be coupled in parallel with other series strings 11 to form a parallel array 13 of PV modules. The parallel arrangement of the array 13 enables the PV series strings 11 to be configured such that the array 13 has common array output terminals 14A, 14B. These common terminals 14A, 14B may be connected to a common DC circuit such as a power processing system, for example an inverter 16.

Additionally, series strings 11 and sub-arrays (not shown) may be grouped together in other combinations as the operating conditions may require.

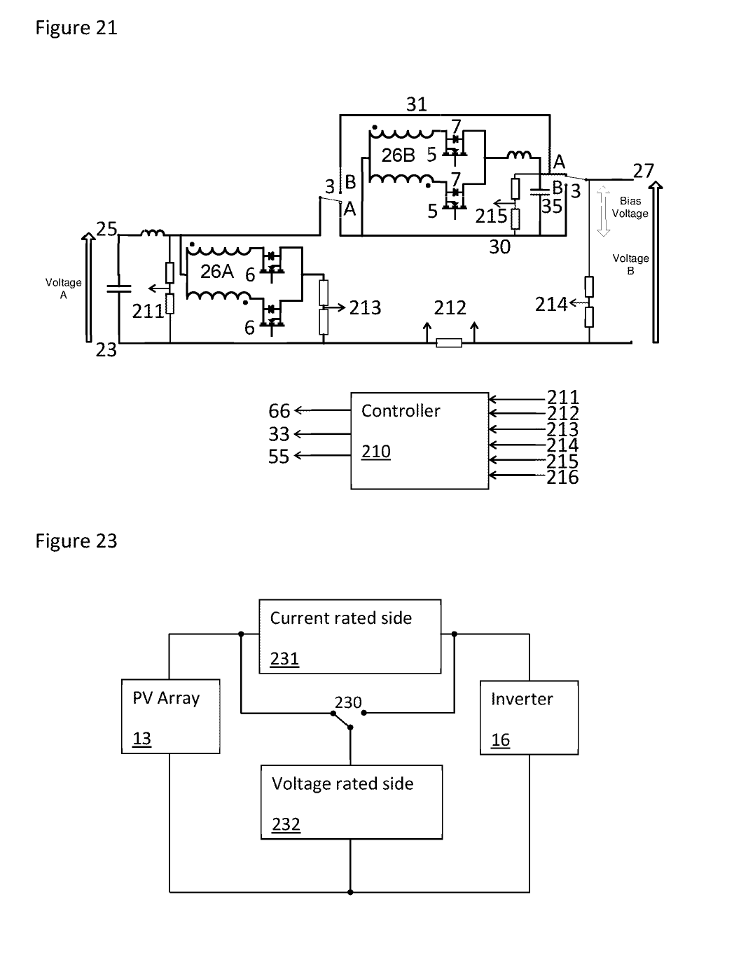

An inline DC/DC converter 15, or other voltage regulator is coupled in series with the PV modules of each series string 11. The converter may be positioned at any point in the series string. Its position may be selected to suit physical constraints, the arrangement for earthing (grounding) due to different manufacturers of PV panels having different earthing requirements, or for enabling a convenient common connection with other series strings 11 by way of output terminals 12A, 12B. The power supply of the converter may be provided by the PV array, to minimise additional cabling, cost and loss associated with providing an external supply, as shown by connection 17 in FIG. 1B. As is shown in FIG. 21, each converter 15 has an associated bias control system comprising support components and a Maximum Power Point (MPP) tracking algorithm within a controller.

As discussed in the background section above, for a given level of irradiance and temperature, each PV cell or module has an optimal DC operating voltage. Ignoring any other circuit influences, each series string 11 will therefore present an optimum DC string voltage to the converter 15 that is variable according to the conditions.

In operation, when a series string 11 as shown in FIG. 1B is exposed to sunlight, the MPP algorithm, together with the control system, adjusts the converter 15 to provide a suitable bias voltage, to be combined with the voltage across the series string of PV modules, to provide a target voltage across the string's output terminals 12A and 12B. Therefore, by using the inline converter 15, the voltage across the series string of PV modules may be adjusted independently of the DC voltage at the output terminals 12A, 12B.

The voltage at the terminals 12A, 12B is typically controlled by the inverter 16 either to a constant voltage or dynamically adjusted to optimise the power output of the system. Each converter 15 can impose a bias voltage on its associated string so that each string 11 is decoupled from the voltage 12A, 12B. This allows the converters 15 to be controlled so that each string 11 can operate at its optimum DC voltage, so long as the difference between this optimum voltage and the voltage 12A, 12B does not exceed the maximum bias voltage of the associated converter 15.

The net effect of this two level control system is that the controller within each converter 15 works to maximise each converter's output power by adjusting the converter bias voltage output, within the limits of its bias voltage rating. At the same time, the inverter controller optimises the level of the DC bus voltage at terminal 14A, 14B to ensure that the maximum system power output is achieved.

Thus, in effect, the converter 15 provides a ‘buffer’ between the optimum voltage across the PV modules of a series string and the voltage output across the terminals 12A, 12B of the series string as a whole. It also provides compensation from external circuit influences on the series string output terminals that would otherwise influence the DC voltage of the PV modules of the series string 11 tending them away from their optimum level output voltage.

In the arrangement of a PV array with a biasing device in each string as illustrated in FIG. 1B, a common inverter 16 may be coupled to the PV array by way of the common array outputs 14A, 14B. The inverter 16 can thereby convert the DC output of the array 14A, 14B to an AC output 19 suitable for connection to the electrical distribution network of the location. This may be used for transmitting power back to the distribution network.

Even when an inverter 16 is connected to the common output terminals 14A, 14B of an array, the in line converter(s) 15 can, by imposing a bias voltage on the DC voltage produced by the series string, be controlled to make adjustments for the local operational conditions for each series string 11 independently of the other series strings, and hence independently of any influence of the common inverter 16 coupled to the common array output 14A, 14B. The common inverter 16 may be adjusted according to an overall MPP algorithm or optimised in accordance with, for example, the parameters of any power distribution to which it is coupled without affecting the efficiency of each individual series string 11. Any change in inverter 16 parameters which may affect the properties of the inverter 16 input do not affect the optimum DC voltage output of each series string 11 as any change in voltage at the output terminals 12A, 12B of each series string 11 is compensated for by the inline converter(s) 15. Thus, the adjustment enabled by converter 15 in each series string 11 allows the inverter 16 coupled across the array 13 to be adapted for optimal operational efficiency based on substantially stable outputs from each of the series strings 11.

For example, the inverter 16 may be controlled by one of the strategies below:

1) the inverter 16 may be set to operate at a particular DC voltage to minimise its losses, for example, its minimum permitted DC bus level. In this case, converter 15 should have the capability to provide the full maximum power point tracking range of the system as the converter may have to provide a bias voltage to compensate from the maximum voltage output of a series string 11 down to the minimum permitted DC bus level of inverter 16.

2) the inverter 16 may be set to operate an MPP tracking algorithm that reacts slower than the MPP tracking algorithm of the converters 15 (for example an order of magnitude slower) so that the two algorithms do not conflict.

Strategy 2 has the following advantages:

i. the converter voltage & power rating may be minimised as the converter would only ever need to provide a bias voltage to account for the imbalance between strings and would therefore be lower cost. This is contrasted with providing the full system maximum power point tracking range of strategy 1.

ii. Within the range of operation of each converter, the inverter's MPP tracking algorithm would operate to find the optimum balance between system losses including string MPP mismatch, converter losses & inverter losses) which would help to maximise the power output at the inverter terminals.

Where it is desired to provide both positive and negative bias voltages (bidirectional) from the same apparatus, for example to selectively operate in boost and buck modes, the output voltage of the bias converter may be halved to provide a given MPP tracking range. For example, a 200V MPP tracking system (unidirectional) could be provided by a 100V bidirectional converter. As the current through the current rated section of the converter is unchanged this allows the power rating of the components used to be significantly reduced (up to half) hence providing reduced costs.

Further, an increased power rating is preferable because it is also desirable for a voltage compensation system to provide as high a bias voltage as practical for increased flexibility of operation in relation to changeable conditions such as irradiance and PV panel degradation. Further it may be advantageous to bias PV array segments containing higher number of panels which would require a higher current rating. A typical power rating of a bias converter 15 would be 10-20% of system power, although a power rating up to 100% could be desired.

The design may be implemented using a number of switching technologies for example IGBTs and MOSFETs. Using MOSFETS would allow the converter to be operated at a reasonably high switching frequency, say 100 kHz which in turn would allow the size (and cost) of magnetic and filtering components to be minimised.

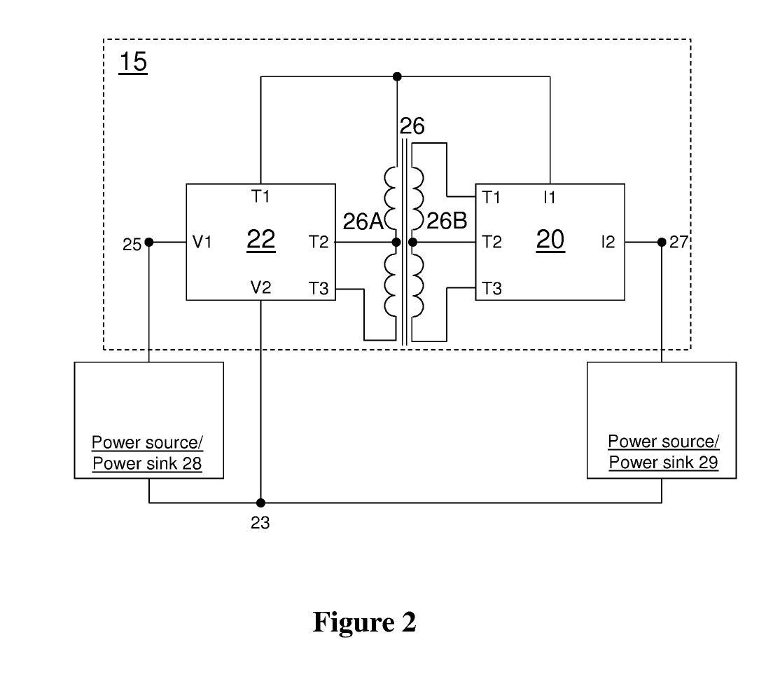

Accordingly, and turning to FIG. 2, a bias converter 15 is shown that comprises a ‘current rated side’ 20 and a ‘voltage rated side’ 22. Sides 20, 22 are separated by an isolating transformer 26 and are combined to produce a bias converter topology tailored to the power rating and the voltage rating of the two halves. Transformer 26 comprises windings 26A and 26B as would be understood. Connections to the transformer 26 are denoted by T1, T2 and T3 as would be understood. Depending on the circuits used in sides 20, 22 it may not be necessary to utilise all of the connections to the transformer 26. Transformer design 26 is optimised for the circuits implemented in sides 20, 22 which may include not implementing unused windings of the transformer. Power Source/Sink 28 is coupled in parallel to voltage rated side 22 across V1 and V2 at nodes 23 and 25. Power Source/Sink 29 is coupled in series to current rated side 20 by way of I1 and I2 and in parallel to nodes 27 and 23. Node 23 may be considered to be a common reference node.

One of Power Source/Sink 28 and Power Source/Sink 29 may comprise a photovoltaic source, i.e. a PV cell, string or array and the other of Power Source/Sink 28 and Power Source/Sink 29 may comprise a PV inverter 16.

Both ‘sides’ should be active arrangements rather than passive arrangements in order to produce a bi-directional system where both a buck bias voltage (where the inverter input voltage is less than the cell or string output voltage) and a boost bias voltage (where the inverter input voltage is more than the cell or string output voltage) may be provided in a selectable buck or boost mode arrangement should the need arise.

In bi-directional designs in particular the ‘sides’ arrangement of FIG. 2 provides an optimum method of system design. Conventional, full power bi-directional DC/DC converters are typically symmetrical. In a bias converter application the input and ‘bias’ voltages can differ dramatically.

With the above combination of different topologies, optimised ‘current rated’ and ‘voltage rated’ sides may be provided which may allow efficiency and cost optimisations for example allowing both sides to efficiently utilise the same switches within the converter.

Accordingly, improved voltage compensation is provided.

### Implementation

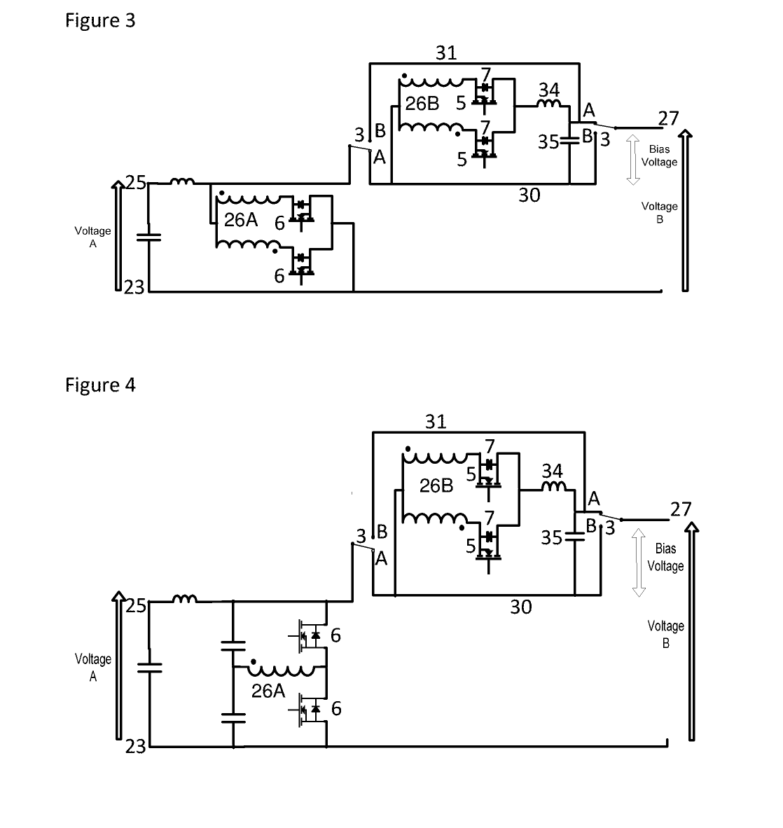

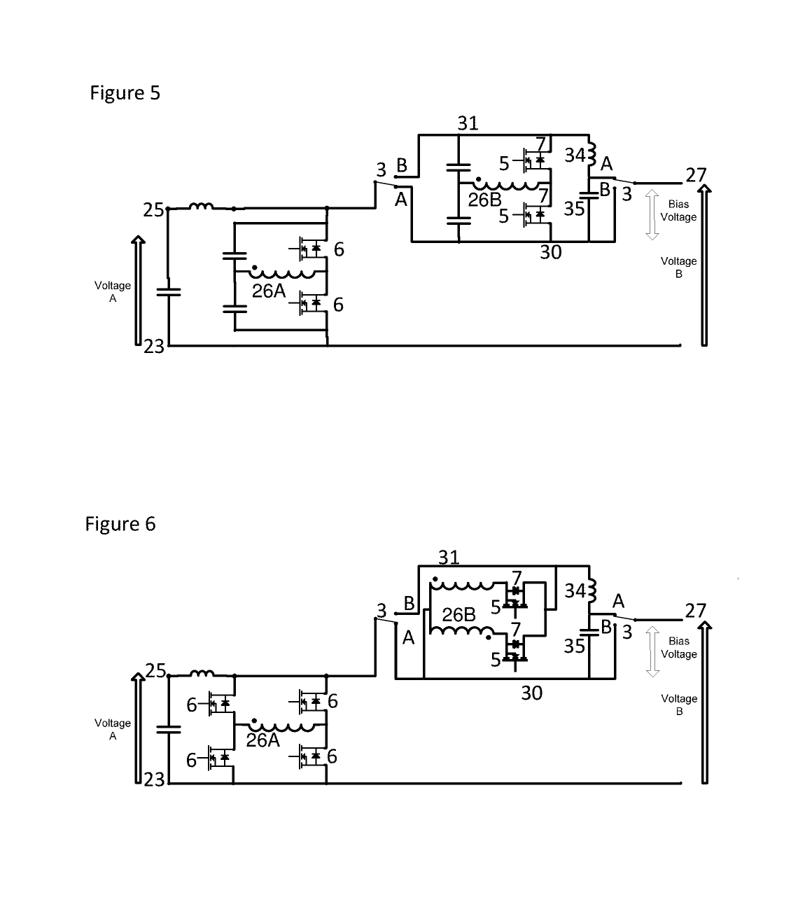

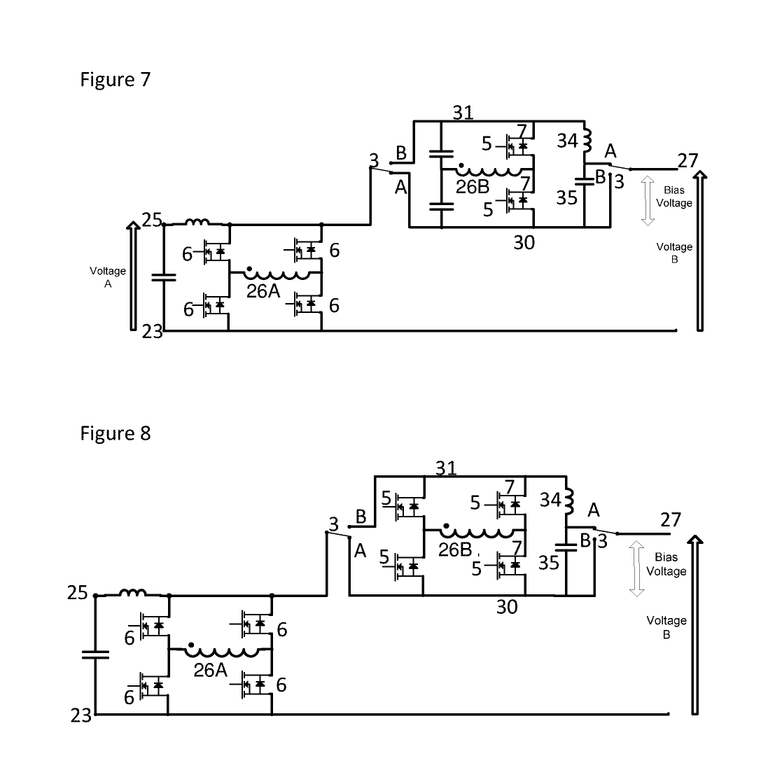

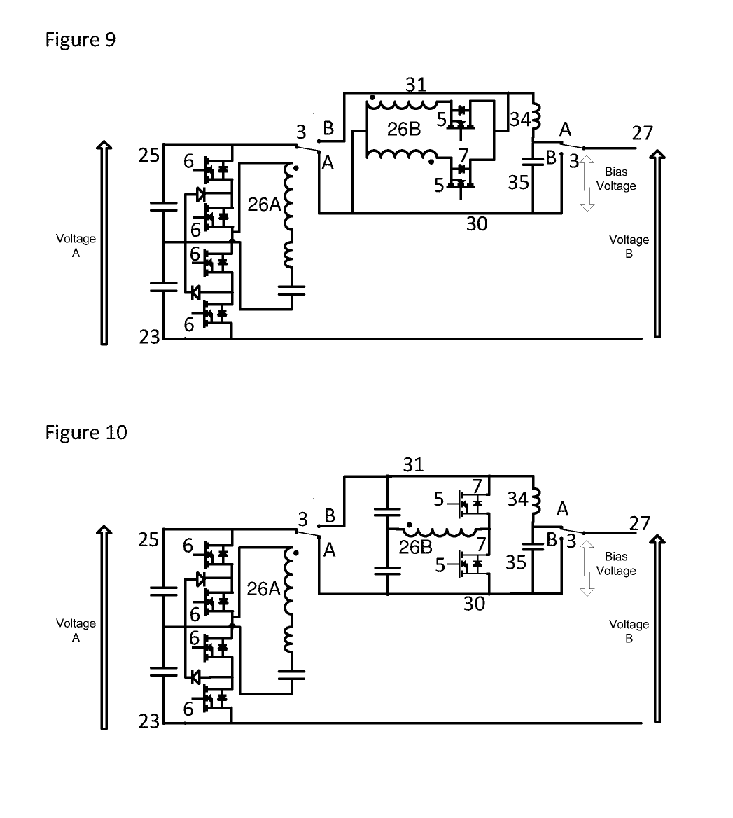

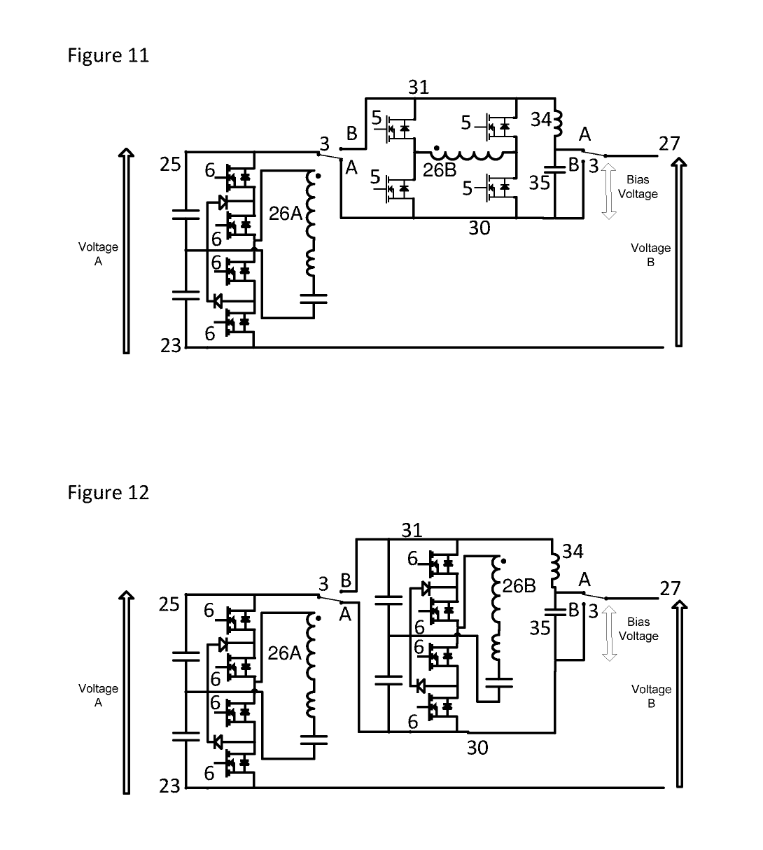

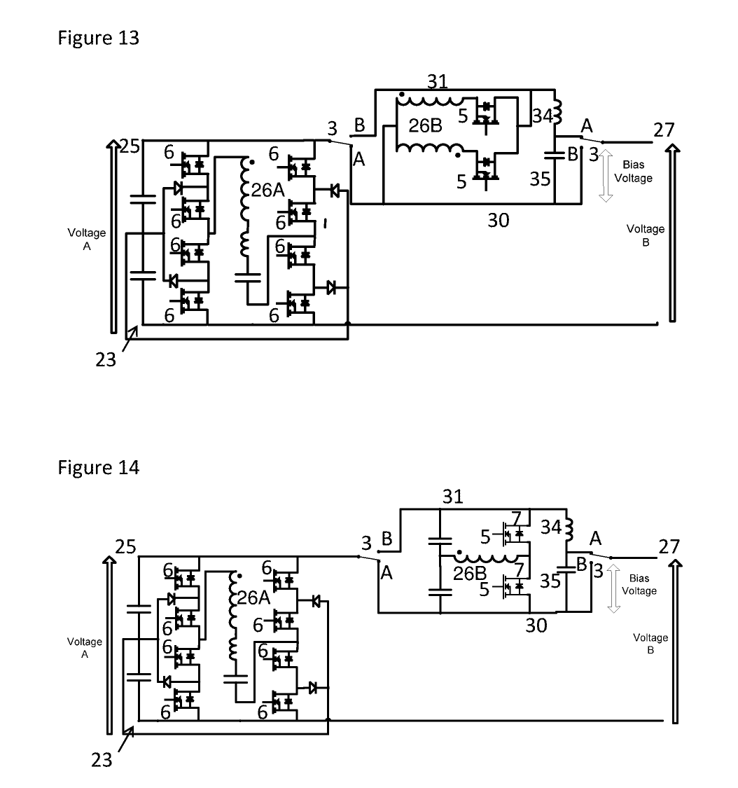

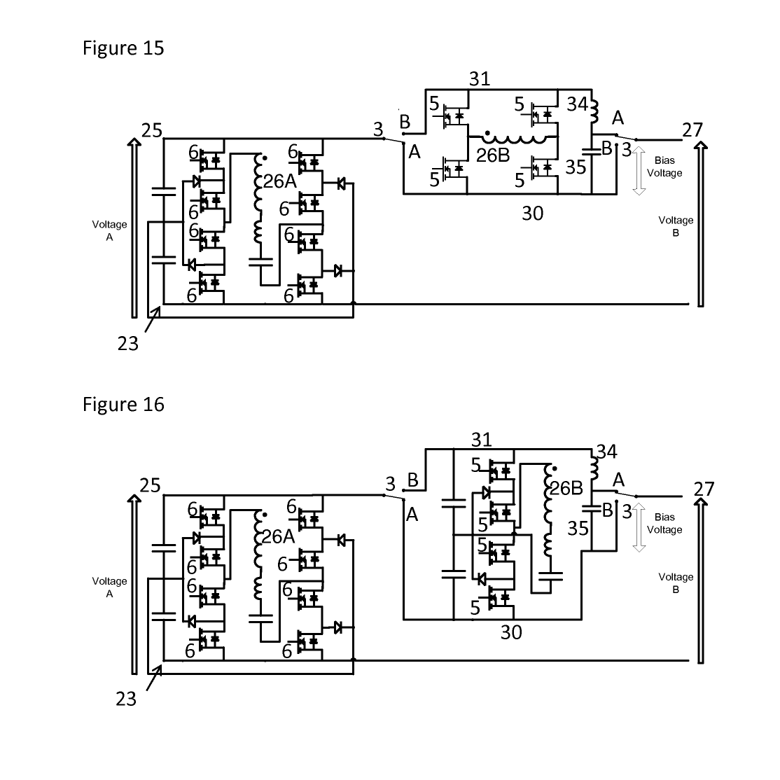

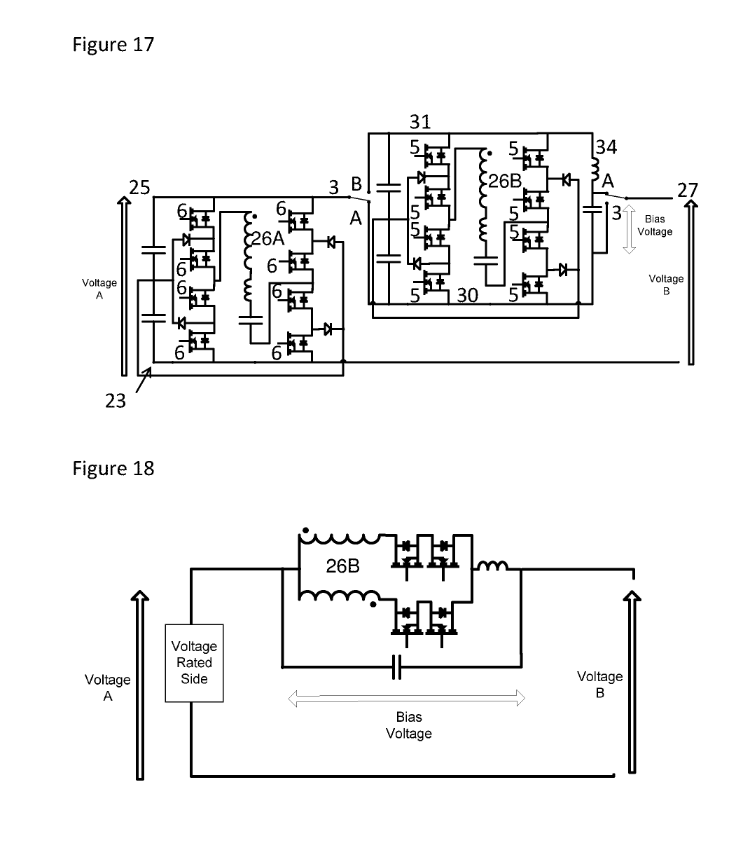

Various topologies may be employed to provide the voltage and current rated sides according to FIG. 2. Turning to FIGS. 3 to 17 in which voltage A denotes the voltage of Power Source/Sink 28 across nodes 25 and 23, and voltage B denotes the voltage of Power Source/Sink 29 across nodes 27 and 23, the following combinations are illustrated:

| Figure | Voltage Rated Side Topology | Current Rated Side Topology |
|---|---|---|
| 3 | Push Pull | Push Pull |
| 4 | Half Bridge | Push Pull |
| 5 | Half Bridge | Half Bridge |
| 6 | Full Bridge | Push Pull |
| 7 | Full Bridge | Half Bridge |
| 8 | Full Bridge | Full Bridge |
| 9 | NPC Half Bridge | Push Pull |
| 10 | NPC Half Bridge | Half Bridge |
| 11 | NPC Half Bridge | Full Bridge |
| 12 | NPC Half Bridge | NPC Half Bridge |
| 13 | NPC Full Bridge | Push Pull |
| 14 | NPC Full Bridge | Half Bridge |
| 15 | NPC Full Bridge | Full Bridge |
| 16 | NPC Full Bridge | NPC Half Bridge |
| 17 | NPC Full Bridge | NPC Full Bridge |

For Clarity, auxiliary components of FIGS. 3 to 17 are not typically shown. Other devices including IGBTs may be used in place of the MOSFET switching devices.

The bi-directional converters of FIGS. 3 to 17 illustrate arrangements that are operable to produce both buck and boost bias voltages from a single converter. In these converters the sides of the transformer are treated as either primary or secondary sides (as would be understood by the skilled person) depending on the mode of operation as follows:

For the avoidance of doubt, the primary side is considered to be the side on the input of a conventional converter with the active switches, the secondary side is the output which is typically passive (although it can be active to lower losses).

In systems where the direction of current flow is fixed, such as photovoltaic systems, and where switches 5 are composed of devices which contain parasitic diodes, such as MOSFETs, it is necessary to reverse the direction of the bias portion of the system depending on buck or boost operation. This may be achieved by using a combination of low frequency switching devices. Two single throw double pole contactors 3 are detailed in FIGS. 3 to 17 for illustration purposes however a number of single pole single throw contactors, semiconductor switches or other devices with similar properties could also be used.

In boost mode, the section of the converter that is in parallel with system voltage (the voltage rated side) is treated as a conventional primary side and controlled via switches 6 in an according manner so that energy is transferred from this side to the secondary side. The converter section that is in series with the system voltages is treated as a conventional secondary side and may comprise active or passive rectification to transfer the energy as a bias voltage. To operate in boost mode, switches 3 are set to position A. The active switches 6 on the voltage rated side are modulated to control the current through the transformer as would be understood. On the current rated side the switches 5 may be operated to act as an active rectifier to reduce losses. The inductor 34 regulates the current, which charges the capacitor 35 to the bias voltage. Once the desired voltage is reached the modulation of the voltage rated switches 6 may be adjusted to maintain the boost voltage at the desired level.

In buck mode the section that produces the bias voltage is controlled in the manner of a conventional primary side so that it transfers energy from this series connected portion to the section of the converter in parallel with the system voltage. In this manner a bias voltage is created. The section of the converter in parallel with the system voltage (the voltage rated side) then uses either passive or active rectification, along with output filtering to transmit this energy to the system. To operate in buck mode, switches 3 are set to position B. The current rated side switches 5 are disabled. This prevents current flowing from the PV array (Voltage A) to the inverter (Voltage B). This will cause the PV array to move towards its open circuit voltage as the current rated side capacitor 35 charges. The current rated side switches 5 are then modulated to maintain the required voltage across the capacitor 35. During this mode of operation the voltage rated side is operated as a rectifier by way of switches 6. This may be an active or a passive rectifier.

Whether the converter side acts as primary or secondary as in a conventional DC/DC converter is dependent on the mode of operation (buck or boost) of the converter. In a PV application the direction of current flow is from the PV array to the inverter. Therefore the direction of bias voltage will determine which side absorbs or transmits power. If the converter needs to reduce the voltage in the array then the current rated, series connected side must absorb power, where as to raise the array voltage this side must output power. A conventional primary is the switched side that absorbs power. In the bias converter it is envisioned that the side that absorbs the power will be actively switched to control the power (acting as a conventional primary) whereas the other side will be controlled as an active rectifier (conventional secondary). For this reason it is more convenient to refer to current rated and voltage rated sides as in FIG. 2. The Current rated side being in series with both the inverter 16 and PV array (or cell or string(s) 11) and the Voltage rated side being in parallel with either the inverter or PV array (or cell, or string(s) 11) dependent on the mode of operation and converter topology arrangement.

In boost mode, the current rated side may be configured as an active DC/DC converter secondary. However, in buck mode, the system must be capable of driving the current through the transformer so that it acts as the primary of a conventional switched mode power supply (SMPS) as the skilled person would understand.

Advantages of the topologies of FIGS. 3 to 17 include allowing a more optimised converter and at a higher power. In ascending order of power capability:

Push Pull

Half bridge

Full bridge

NPC half bridge

NPC full bridge

Voltage stress on individual switching devices decreases down the list (at the expense of using additional switches). This allows the use of lower voltage, less lossy switching devices and dissipates loss in a greater number of devices.

In general, the above topologies provide the following properties:

A transition from half bridge to full bridge and from NPC half bridge to NPC full bridge halves the current required in the transformer winding but doubles the number of switching devices required on that side of the switching topology.

A transition from full bridge to NPC doubles the current in the transformer but halves the voltage rating of the switches.

A transition from push pull to half bridge allows more efficient use of the transformer as one transformer winding is fully utilised rather than being split, and also halves the voltage across the switches.

In general, as the desired power level of the system increases, it is more cost effective to utilise a topology from the lower end of the list for any given system specification.

The new converter topologies of FIGS. 3 to 17 are capable of producing the voltage compensation necessary for effective solar balancing (of a PV array) at an acceptable cost and efficiency.

Should the current rated side comprise MOSFETs 5 (or other switching devices with a parasitic diode 7), identified in FIG. 3 but also present in FIGS. 4 to 17 then the parasitic diodes should be placed to block the bias voltage otherwise the maximum bias that could be produced would be one diode drop, for example, approximately 0.6V.

FIGS. 3 to 17 illustrate one solution suitable for most arrangements of the current rated side (push-pull, half bridge, full bridge, NPC Half Bridge, NPC Full Bridge). Here, the whole current rated side may be electrically reversed. This allows the system to be configured so that the parasitic diodes do not interfere with the circuit operation. This is illustrated using a DPDT contactor 3 however an arrangement of semi-conductor switches, SPST contactors or other configuration may be used alternatively.

If contactors are used, the normally closed (NC) contacts may be arranged so that a transparent failure mode may be in operation when the bias converter 15 is unpowered. This allows voltage A and voltage B to be coupled without any bias control. This increases fault resistance as array disconnection is avoided by way of array 11 remaining able to provide power to an inverter 16 (albeit possibly in a sub-optimal mode) if the bias converter is not operating. This is achieved by positioning the contacts so that either line 30 or 31 completes the circuit between voltage A and voltage B as can be seen in FIG. 3 and as equally applies to FIGS. 4 to 17 as would be understood.

An alternative solution shown in FIG. 18 to mitigate parasitic diodes 7 is to reconfigure the MOSFETS as semiconductor switches by paralleling two MOSFETS connected in opposite directions so that the parasitic diodes are opposed to one another and may therefore block a voltage of either polarity. With this arrangement, the contactors 3 shown in FIGS. 3-17 are not required for bi directional operation on the current rated side, however, the switches of the current rated side must be controlled as an active rectifier when used in boost mode. This is because the parasitic diodes are blocked so there is no path for the current when these switches are open. This configuration, however, does not inherently provide a transparent failure mode as described above.

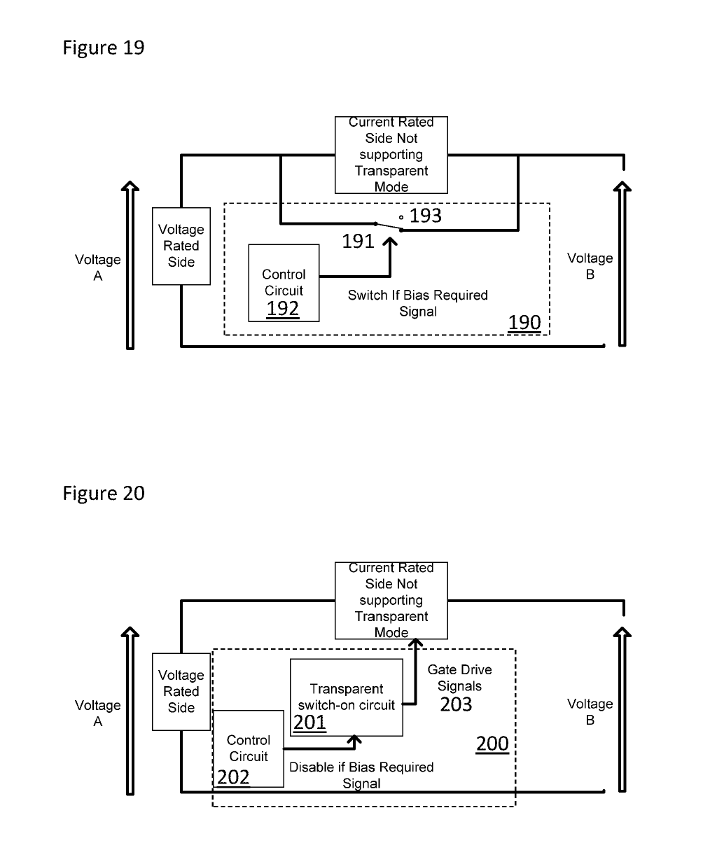

FIG. 19 shows an auxiliary circuit 190 that may provide the transparent failure mode function if one should not inherently be present. Such a circuit could also serve to reduce ‘transparent’ mode losses in converters that do have an inherent transparent mode. Auxiliary circuit 190 may comprise a NC contactor 191 or other switch to short out the current rated side when the bias converter is not actively producing a bias and a corresponding control circuit 192. The auxiliary circuit can be disabled (position 193) by control circuit 192 when a bias is desired to further increase the system's fault tolerance.

Alternatively, and as shown in FIG. 20, a secondary circuit 200 comprising a transparent switch-on circuit 201 and a control circuit 202 may be provided. The secondary circuit is arranged to switch one or more of the switching devices 5 in the current rated side by way of gate drive signal(s) 203 from transparent switch-on circuit 201. As a result, a current path is available between voltage A and voltage B when no bias is being produced, and hence a transparent failure mode is provided.

Turning to FIG. 23, to maximise efficiency it is desirable to avoid re-circulating energy within the converter as would be understood by the skilled person. If the converter is operating as a boost converter it is more efficient to have the voltage rated side connected across the PV array as the energy flow through the converter is of the form PV array 13-voltage rated side 232-current rated side 231-Inverter 16. If the converter is operated as a buck converter then it is more efficient to have the voltage rated side connected across the inverter so that the energy flow through the converter is of the form PV array 13-current rated side 231-voltage rated side 232-inverter 16. The energy transfer between the two sides of the converter occurs through transformer 26 (FIG. 2) as would be understood by the skilled person.

Optionally, the converter topology may be reconfigured on the fly by way of switch 230. Typically this would occur when a bidirectional converter switches its mode of operation from boost to buck or vice versa. The switch may be any suitable switching means such as a MOSFET, IGBT or other arrangement of semiconductor switches, or mechanical contactor(s).

Alternatively, it is also possible to achieve the above reconfiguration by moving the current rated side which would require a more complex switching arrangement than that of FIG. 23.

### Control

Turning to FIG. 21, there is illustrated an embodiment showing a push pull-push pull converter as illustrated in FIG. 3 arranged as part of a bias control system.

A controller 210 is associated with each converter 15. The Control contains both a switchmode controller to modulate the switches and an MPP tracking algorithm. The MPP is most effectively tracked at the output of the converter so that the converter losses are taken into account. The algorithm may be provided by way of software download to a programmable controller device 210 such as, but not limited to a microcontroller, or may be hard-wired into the controller by other means such as an application specific integrated circuit (ASIC) field programmable gate array (FPGA) or conventional digital or analogue circuitry. The support components which, as can be seen, can be low-cost resistive components, provide measurement points of the series string and enable the controller 210 to be supplied with the information upon which the MPP algorithm contained within may be applied.

The controller 210 receives series string inputs indicative of voltage A 211 and adjusted string output voltage (voltage B) 214. The controller may also receive signals indicative of string current 212 and/or converter current 213. Optionally, a signal indicative of string current 212 may be taken at either the positive or negative side of the string. Optionally, a signal indicative of converter current 213 may be taken in either the voltage rated sides of the converter as shown, or in series with capacitor 35 in the current side. The bias voltage may be calculated from a signal indicative thereof at point 215, or may be derived from the difference between voltage A and voltage B. As previously described, the converter 15 is self-contained, requiring no external coupling to any other series string. The controller 210 may be arranged to modulate switches 5 and/or 6 by way of output or outputs 55 and 66 respectively to provide a pulse-width modulation or other common switching scheme to the flow of current in the converter 15 to respond to the voltage demand from the MPP tracking algorithm as described previously. Outputs 55 and 66 may comprise individual outputs for each switch 5, 6 respectively. This action imposes a corresponding bias on the optimum DC voltage output of the series string of PV modules, resulting in an independently controllable DC string output voltage across terminals 12A and 12B.

The bias voltage may be controlled using any of the control schemes previously described.

The converter 15 is typically independent and self-contained. However, the controller 210 may be provided with data communications capabilities. A separate control input 216 to the controller 210 can be used by an external system to send a control signal to the controller 210. This could, for example, adjust the action of the converter 15 such that the bias voltage imposed on the series string 11 can be adjusted for reasons external to the converter 15, rather than for maintaining the optimum voltage across the series strings. The local measurements provided by inputs 211 to 215 could, therefore, be overridden by the separate control input 216 if desired. Additionally or alternatively, the controller 210 may be provided with condition monitoring capabilities to communicate monitoring data such as series string operating parameters to a remote monitoring device, for example, to detect faults with the string.

The embodiment illustrated in FIG. 21 includes a controller 210 for its respective converter in each string. However, a single controller may also be arranged to monitor and control two or more converters in their respective strings. This requires a controller of sufficient processing speed and power to enable multiplexing without affecting controller performance.

As described earlier, switches 3 are manipulated dependent on whether a buck or boost mode of operation is desired by the MPP tracking algorithm. Controller 210 may be programmed to provide output or outputs 33 to set the switches to the desired position for buck or boost operation based on the zero point of provided bias voltage as would be understood. The controller may be further programmed to disable the power stage of the converter at the point that the mode of operation is changed, for example if switches 3 comprise contactors (mechanical).

The controller 210 may be programmed to disable the converter (for example by setting the switches 3 to transparent mode as discussed earlier) when there is no power being provided by the PV array. Should the controller and converter be powered from the array itself (connection 17 in FIG. 1B) then this would be implicit.

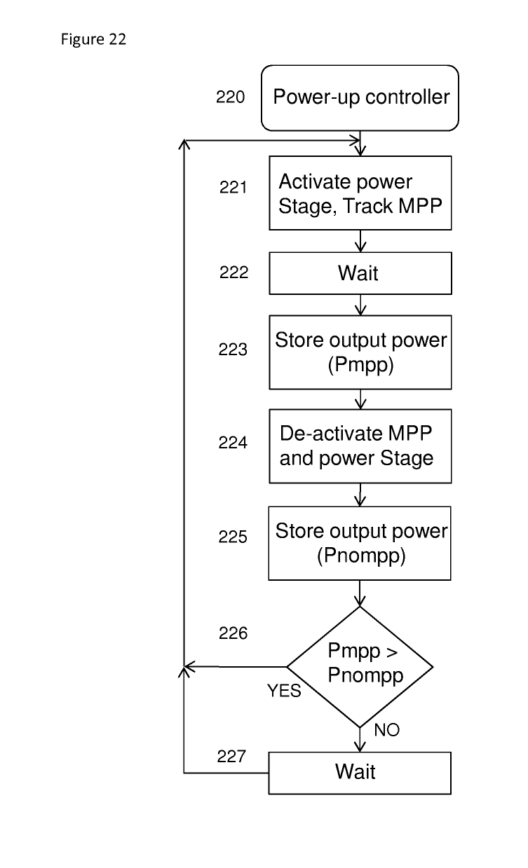

The controller may also be programmed to act in the following manner as shown in FIG. 22 in order to optionally determine whether the bias converter is providing a benefit to the system. For example at very low values of bias voltage, the losses consumed by the MPP tracking system including the bias converter may exceed the additional yield from tracking a string's MPP. This can be determined by periodically deactivating the converter and comparing the output power with and without the power stage activated. Thus, at step 220, if power is available from the array, or if the controller has an external power source, the controller is powered up. At step 221 the converter power stage is activated and the controller begins to track to the MPP of the system. The flow then waits a time at step 222. At step 223, the output power value or a value indicative thereof with MPP tracking enabled (Pₘₚₚ) is measured and stored in a memory of the controller or a memory associated with the controller. At step 224, the converter power stage is deactivated so that no MPP tracking is enabled. At step 225, the output power value or a value indicative thereof with MPP tracking not enabled (Pₙₒₘₚₚ) is measured and stored in a memory of the controller or a memory associated with the controller. At step 226, the power value or signal indicative thereof with MPP tracking enabled is compared to the power value or signal indicative thereof with no MPP tracking enabled. If Pₘₚₚ is greater than Pₙₒₘₚₚ then flow returns to step 221 and MPP tracking continues. However, if Pₘₚₚ is not greater than Pₙₒₘₚₚ then the flow waits a time at step 227. After the wait period has elapsed, flow returns to step 221 where MPP tracking is re-enabled and the controller executes the above steps once more.

Optionally the length of the ‘wait’ blocks (222, 227) in FIG. 22 may be programmatically adapted to the operating conditions e.g. wait=f (Array power, bias voltage at the MPP, power stage loss characteristic). One implementation of this would be to increase the length of the wait 222 (when MPP tracking is enabled) and reduce the length of wait 227 (when MPP is not enabled) in proportion to the bias voltage at MPP. In this manner, at low bias voltages, the benefit or advantage of the converter would be checked regularly.

The controller may also be programmed to provide signals to switches 5 via output or outputs 55 for enabling active rectification during boost mode and/or switches 6 via output or outputs 66 during buck mode.

Further, the controller may also be programmed to provide any or all of the functionality and signals of auxiliary circuit 190 and/or secondary circuit 200 as described in relation to FIGS. 19 and 20.

The controller of FIG. 21 can also be utilised with any of the embodiments of FIGS. 4 to 20 and 23 in a similar manner.

In another embodiment there is arranged a converter that produces a high voltage bias between two lower voltage sources. This configuration could use a simpler topology, such as the full bridge, in parallel with a source and a more complex topology, for example an NPC topology in series with the source to produce the bias output. This may be beneficial in some applications however the gains that could be made from using this configuration, compared to using a full power converter, in a typical application are likely to be very small. This embodiment is therefore arranged to produce a bias voltage between two sources that operate at different nominal voltages to allow power to be transferred between the two. Alternatively, the two sources may operate at two nominally similar voltages and a small bias voltage is produced to enable the system to operate at maximum efficiency.

In FIGS. 3 to 17, the NPC topologies are shown comprising a diode clamping arrangement. Alternative voltage balancing arrangements are also possible without changing the nature of the design including flying capacitor, flying capacitor with diode clamping or other voltage balancing arrangement as would be understood by the skilled person.

Thus, it is possible to create a bi-directional bias converter by using two primary sides from a variety of DC/DC converter topologies and connecting them in a bias configuration. This is advantageous as different topologies are more cost effective to use at different voltages. The ‘voltage rated’ and ‘current rated’ sides of a bias converter may operate at two different voltages. Thus, depending on the system voltage, bias (trim) voltage and power requirements, an optimised bi-directional solution can be produced.

The embodiments described herein may be achieved by retrofitting a DC/DC converter within an existing series string of PV modules. This could replace existing converters which are arranged to convert the entire output of a series string or array, hence providing significant energy savings. The embodiments described herein may also be fitted to systems that are operating without converters and hence showing reduced yield due to voltage imbalance.

1. An apparatus for producing a compensated voltage output comprising:
a first power source or power sink coupled between a first node and a reference node;
a second power source or power sink coupled between a second node and the reference node;
a biasing means comprising one portion coupled between the first node and the reference node, and another portion coupled between the first node and the second node; wherein
the biasing means is operable to generate a controllable bias voltage of either polarity between the first and second nodes to produce the compensated voltage output.

2. An apparatus as claimed in claim 1 wherein the two portions of the biasing means are coupled by a transformer, and optionally wherein both portions of the biasing means are active.

3. An apparatus as claimed in claim 1 wherein the biasing means is arranged such that the power throughput of the biasing means is proportionate only to the bias voltage generated by the biasing means.

4. An apparatus as claimed in claim 1 wherein one of the first and second power source or sink comprises a photovoltaic module or photovoltaic cell, and optionally further comprising a plurality of photovoltaic modules or cells coupled together in series and wherein the biasing means and the photovoltaic modules form a compensatable series string with voltage output terminals, and further optionally comprising a plurality of the series strings coupled in parallel such that the output terminals of the series strings provide a common photovoltaic module array output.

5. An apparatus as claimed in claim 1 wherein one portion of the biasing means is rated for at least the maximum voltage of one of the power sources or power sinks, and the other portion is rated for at least the maximum current rating of one of the power sources or power sinks.

6. An apparatus as claimed in claim 1 further arranged to enable the direction of current flow in the portion of the biasing means coupled between the first and second nodes to be reversed.

7. An apparatus as claimed in claim 1 arranged such that the biasing means may be bypassed to directly connect the first and the second nodes.

8. An apparatus as claimed in claim 1 wherein at least one portion of the biasing means comprises MOSFET and/or IGBT switches, and optionally wherein the switches are arranged so as to negate the effects of parasitic diodes of the switches, and further optionally wherein the parasitic diodes of a switch are negated by placing a second switch in series so that the connection between the switches joins the anodes of both parasitic diodes or the cathodes of both parasitic diodes.

9. An apparatus as claimed in claim 1 arranged such that the portion of the biasing means coupled between the first node and the reference node may be selectively swapped to be alternatively coupled between the second node and the reference node.

10. An apparatus as claimed in claim 1 wherein the biasing means further comprises:
a control device;
first node and second node voltage measuring means; and is
arranged such that the control device is operable to control the bias voltage imposed between the first and second nodes to produce the compensated voltage output, and optionally wherein the control device is arranged to control the current flowing in the biasing means.

11. An apparatus as claimed in claim 10 wherein the control device comprises an input for receiving a control signal such that the bias voltage is controllable by the received control signal.

12. An apparatus as claimed in claim 10 wherein the control device further comprises data communication means for providing power sink or source operating data to a monitoring device such that operating parameters of at least one power sink or source can be remotely monitored.

13. An apparatus as claimed in claim 10 wherein the control device is further arranged to select the polarity of the bias voltage between the first and second nodes.

14. An apparatus according to claim 10 wherein the control device is further arranged to bypass the biasing means by connecting the first and second nodes directly.

15. An apparatus according to claim 4 wherein the other of the first and second power source or sink comprises a PV inverter.

16. An apparatus as claimed in claim 1 wherein one or both of the first and second power source or sink comprises a DC link of an inverter, and optionally wherein the AC output of the inverter is connected to the electricity grid.

17. A method of providing a compensated voltage output from an apparatus according to claim 1, the method comprising the steps of:
modulating a first voltage with a bias voltage generated by the biasing means such that the first voltage is selectively modulated by a controllable bias voltage of either polarity to produce the compensated voltage.

18. A method as claimed in claim 17 further comprising the steps of:
measuring the power generated or dissipated in either the first or second power source or power sink;
inputting the measurements to a maximum power point algorithm of a control device of the biasing means;
providing a control output from the control device to control the biasing voltage imposed by the biasing means between the first and second nodes.

19. A method as claimed in claim 17 further comprising the steps of:
receiving at the control device, an input signal from an external device external to the circuit where the biasing means is positioned; and
adjusting the control output such that the biasing voltage is controllable by the external device.

20. A method as claimed in claim 17 further comprising the step of:
providing power sink or source operating data to a monitoring device such that operating parameters of the power sink or source can be remotely monitored.
